(19) United States
(12) Patent Application Publication
(10) Pub. No.: US 2020/0368834 A1
(43) Pub. Date: Nov. 26, 2020

(54) CUTTING INSERT AND ROTARY CUTTING TOOL

(71) Applicant: Kennametal India Limited, Bangalore (IN)

(72) Inventors: Padmakumar MUTHUSWAMY, Bangalore (IN); Bharath Arumugam, Bangalore (IN)

(21) Appl. No.: 16/867,679

(22) Filed: May 6, 2020

(30) Foreign Application Priority Data
May 7, 2019 (IN) 201941018301

(51) Int. Cl. B23D 61/06; B23D 61/02

(52) U.S. Cl. CPC B23D 61/06; B23D 61/025

(57) ABSTRACT

A cutting insert includes a body portion having an upper surface, a lower surface located opposite the upper surface, and side surfaces extending between the upper surface and the lower surface. The body portion disposed about an axis passing through the upper and lower surfaces. The cutting insert further including a plurality of projecting portions provided integrally with the body portion at an outer position thereof in a direction orthogonal to the axis. Each projecting portion has an upper and lower surface, two side surfaces, a side end surface extending between the side surfaces, a round corner surface extending between the upper and side end surfaces, and a cutting edge formed between at least one of the side surfaces and the side end surface. The side surface of each projecting portion is structured to engage a first or second contact surface of a mounting seat formed in a cutter body.

### RELATED APPLICATION DATA

The present application claims priority pursuant to 35 U.S.C. § 119(a) to Indian Patent Application Number 201941018301 filed May 7, 2019, which is incorporated herein by reference in its entirety.

### FIELD

The present invention relates to cutting inserts and to cutting tools in which the cutting inserts are mounted. More particularly, the present invention relates to tangential cutting inserts for use in grooving (slotting) and indexable rotary cutting tools in which such cutting inserts are indexably mounted.

### BACKGROUND

An indexable side cutter is a conventional rotary cutting tool which can carry out grooving. In general, the grooving needs to provide a round corner formed of a curved surface, that is, a curved corner surface, in a corner between a groove bottom processed in a workpiece and a side wall surface continuous with the groove bottom. Stress is likely to concentrate between the groove bottom and the side wall surface. Thus, without the curved corner surface, the workpiece may be cracked starting from the corner portion and may thus be likely to be damaged. Consequently, it is important for the indexable side cutter to include a cutting insert which allows round chamfering for various sizes, that is, processing for forming a curved surface, to be carried out on groove corners.

A conventional cutting insert is shaped, for example, as shown in FIG. 22. A cutting insert 301 such as shown in FIG. 22 is of a tangential type which appears shaped substantially like a rectangle in a plan view. Insert 301 includes cutting edges 305 formed at edges of a set of opposite side surfaces 303, that is, the side surfaces 303 positioned opposite each other, and round corner surfaces, that is, curved corner surfaces 307, formed to extend between opposite side surfaces 303. The corners of cutting edges 305 extending along the edges of round corner surfaces 307 can serve to form curved corner surfaces at corners of a groove.

In general, when a cutting insert is mounted in a tool body of a cutting tool, the cutting insert is preferably mounted so as to have a radial rake angle of, for example, 0 degrees. or a positive radial rake angle. Alternatively, even if the radial rake angle is negative, the cutting insert is preferably mounted in the tool body so as to reduce the level of the negativity. A reason for this is that a larger negative radial rake angle increases impact and cutting resistance resulting from cutting of a cutting edge into a workpiece, thus increasing the possibility of damaging the cutting insert.

For the conventional cutting insert 301 shown in FIG. 22, the length between side surfaces 303 needs to be reduced in order to arrange the cutting insert such that the cutting insert has a small negative radial rake angle or a positive radial rake angle around the tool body of the rotary cutting tool. However, the length between side surfaces 303 of cutting insert 301, that is, the length of round corner surface 307, is equal to the diameter of an inscribed circle of the cutting insert as seen in a plan view. That is, the length between side surfaces 303 is in proportion to the size of cutting insert 301 as a whole. Thus, reducing the length between side surfaces 303 needs to decrease the size of cutting insert 301 as a whole. However, cutting insert 301 needs to include a mounting hole, for attaching and detaching of the cutting insert to a tool body, formed in the center thereof and having a given size. Hence, a simple reduction in the size of the cutting insert may disadvantageously significantly decrease the strength of the cutting insert. Furthermore, a simple increase in the size of the round corner surface correspondingly reduces the contact area between an abutment surface of an insert mounting seat in the tool body and side surfaces 303 of cutting insert 301. This may disadvantageously hinder cutting insert 301 from being appropriately fixed.

U.S. Pat. No. 9,457,413 describes cutting inserts and tool bodies which attempt to improve upon such insert design such as illustrated in FIG. 22. However, such designs still allow much room for improvement.

### SUMMARY

In summary, as one aspect of the invention a cutting insert comprises: an insert body portion comprising: a body portion upper surface; a body portion lower surface located opposite the body portion upper surface; and body portion side surfaces extending between the body portion upper surface and the body portion lower surface, the insert body portion being disposed about an axis which passes through the body portion upper surface and the body portion lower surface; and a plurality of projecting portions each comprising a cutting edge, each projecting portion provided integrally with the insert body portion at an outer position of the insert body portion in a direction orthogonal to the axis. Each projecting portion comprises: a projecting portion upper surface connected to the body portion upper surface; a projecting portion lower surface connected to the body portion lower surface; two projecting portion side surfaces, each connected to the corresponding body portion side surface; a projecting portion side end surface extending between the two projecting body portion side surfaces; and a round corner surface formed thereon and extending between the projecting portion upper surface and the projecting portion side end surface. Each cutting edge is formed between the projecting portion side surface and the projecting portion side end surface, such that the projecting portion side surface serves as a rake face. Each projecting portion side surface is structured to engage either of a first contact surface or a second contact surface of a mounting seat formed in a cutter body. All the projecting portions are identical to one another.

Each projecting portion side surface may be formed as a planar surface.

The length between the two projecting portion side surfaces may be larger than a thickness of the insert body portion.

The projecting portions may be formed such that when the body portion upper surface of the insert body portion appears shaped like a polygon, the projecting portions are positioned at vertices of the polygon.

The body portion upper surface of the insert body portion may be shaped substantially like a triangle.

Each projecting portion may be formed substantially plane-symmetrically with respect to a first plane that extends so as to contain the axis of the insert body portion.

None of the projecting portion side surfaces may be visible in a top view of the insert body portion upper surface and all of the projecting portion side surfaces may be visible in a bottom view of the insert body portion lower surface.

Each projecting portion may further comprise a rake face disposed at a non-zero angle between each projecting portion side surface and the projecting portion side end surface.

Each projecting portion, when viewed looking at the projecting portion side end surface thereof, may be of a trapezoidal shape.

The side surfaces of each projecting portion may taper inward, when moving from the projecting portion upper surface to the projecting portion lower surface, at an angle. The angle may be about 5 degrees.

As another aspect of the invention, a cutter body for a rotary cutting tool comprises: a first end surface and a second end surface positioned opposite the first end surface, each end surface shaped substantially like a circle; an outer peripheral surface extending between the first end surface and the second end surfaces; and a number of insert mounting seats provided in the tool body, each insert mounting seat being structured to support a cutting insert such as previously described.

The number of insert mounting seats may comprise a plurality of insert mounting seats, wherein at least one of the plurality of insert mounting seats is formed at least partially in the first and surface, and wherein at least another one of the plurality of insert mounting seats is formed at least partially in the second end surface.

As yet another aspect of the invention, a rotary cutting tool comprises: a cutter body comprising: a first end surface and a second end surface positioned opposite the first end surface, each end surface shaped substantially like a circle, an outer peripheral surface extending between the first end surface and the second end surface, and a number of insert mounting seats provided in the tool body; and at least one cutting insert as previously described coupled to the cutter body and supported in one of the number of insert mounting seats.

The number of insert mounting seats may comprise a first insert mounting seat which is open in one of the first end surface or the second end surface and a second insert mounting seat which is open in the other of the first end surface or the second end surface, and wherein the at least one cutting insert comprises a first cutting insert coupled to the cutter body and supported in the first insert mounting seat and a second cutting insert coupled to the cutter body and supported in the second insert mounting seat.

For a better understanding of exemplary embodiments of the invention, together with other and further features and advantages thereof, reference is made to the following description, taken in conjunction with the accompanying drawings, and the scope of the claimed embodiments of the invention will be pointed out in the appended claims.

### BRIEF DESCRIPTION OF THE DRAWINGS

FIG. 1 provides a perspective view of a cutting insert in accordance with one example embodiment of the present invention;

FIG. 2 provides a top view of the cutting insert of FIG. 1;

FIG. 3 provides a side elevation view of the cutting insert of FIG. 1 as viewed from line 3-3 of FIG. 2;

FIG. 4 provides a side elevation view of the cutting insert of FIG. 1 as viewed from line 4-4 of FIG. 2;

FIG. 5 provides a perspective view of a cutting tool in accordance with one example embodiment of the present invention having a plurality of cutting inserts, such as the cutting insert of FIG. 1;

FIG. 5B is a detail view of the portion 5B of the cutting tool indicated in FIG. 5;

FIG. 6 is an end elevation view of the cutting tool of FIG. 5;

FIG. 6B is a detail view of the portion 6B of the cutting tool indicated in FIG. 6;

FIG. 7 is a side elevation view of the cutting tool of FIG. 5;

FIG. 8 provides a perspective view of another cutting insert in accordance with one example embodiment of the present invention;

FIG. 9 provides a top view of the cutting insert of FIG. 8;

FIG. 10 provides a side elevation view of the cutting insert of FIG. 8 as viewed from line 10-10 of FIG. 9;

FIG. 11 provides a side elevation view of the cutting insert of FIG. 8 as viewed from line 11-11 of FIG. 9;

FIG. 12 provides a perspective view of another cutting tool in accordance with one example embodiment of the present invention having a plurality of cutting inserts, such as the cutting insert of FIG. 8;

FIG. 13 is an end elevation view of the cutting tool of FIG. 12;

FIG. 14 is a side elevation view of the cutting tool of FIG. 12;

FIG. 15 provides a perspective view of yet another cutting insert in accordance with one example embodiment of the present invention;

FIG. 16 provides a top view of the cutting insert of FIG. 15;

FIG. 17 provides a side elevation view of the cutting insert of FIG. 15 as viewed from line 17-17 of FIG. 16;

FIG. 18 provides a side elevation view of the cutting insert of FIG. 15 as viewed from line 18-18 of FIG. 16;

FIG. 19 provides a perspective view of another cutting tool in accordance with one example embodiment of the present invention having a plurality of cutting inserts, such as the cutting insert of FIG. 15;

FIG. 20 is an end elevation view of the cutting tool of FIG. 19;

FIG. 21 is a side elevation view of the cutting tool of FIG. 19; and

FIG. 22 is a perspective view of a conventional cutting insert.

### DETAILED DESCRIPTION

It will be readily understood that the components of the embodiments of the invention, as generally described and illustrated in the figures herein, may be arranged and designed in a wide variety of different configurations in addition to the described exemplary embodiments. Thus, the following more detailed description of the embodiments of the invention, as represented in the figures, is not intended to limit the scope of the embodiments of the invention, as claimed, but is merely representative of exemplary embodiments of the invention.

Reference throughout this specification to “one embodiment” or “an embodiment” (or the like) means that a particular feature, structure, or characteristic described in connection with the embodiment is included in at least one embodiment of the invention. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in at least one embodiment. In the following description, numerous specific details are provided to give a thorough understanding of embodiments of the invention. One skilled in the relevant art may well recognize, however, that embodiments of the invention can be practiced without at least one of the specific details thereof, or can be practiced with other methods, components, materials, et cetera. In other instances, well-known structures, materials, or operations are not shown or described in detail to avoid obscuring aspects of the invention.

As used herein, the term “about”, when used in conjunction with numerical values, is intended to cover such numerical value as well as values within reasonable tolerances of such value as would be recognized by one of ordinary skill in the art. As used herein, the term “number” shall be used to refer to any integer quantity greater than zero (i.e., one or more than one).

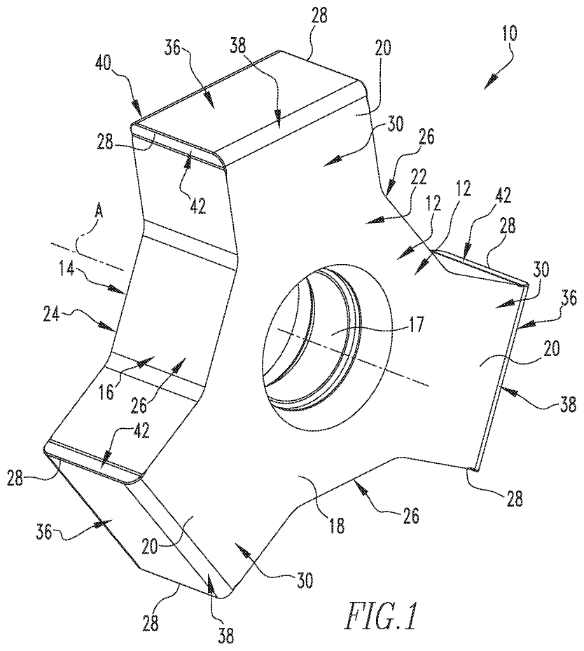

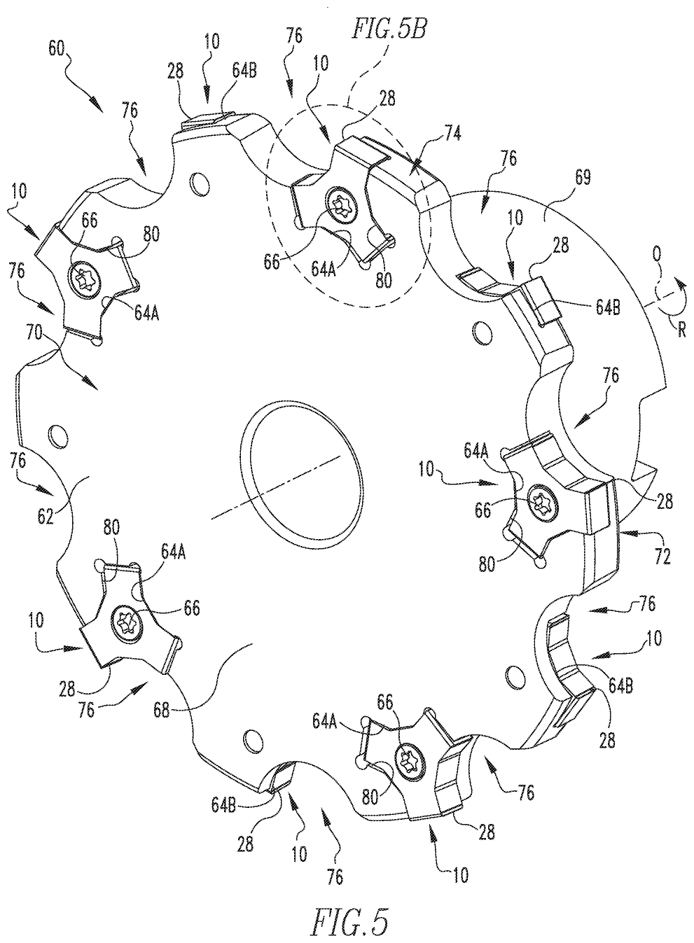

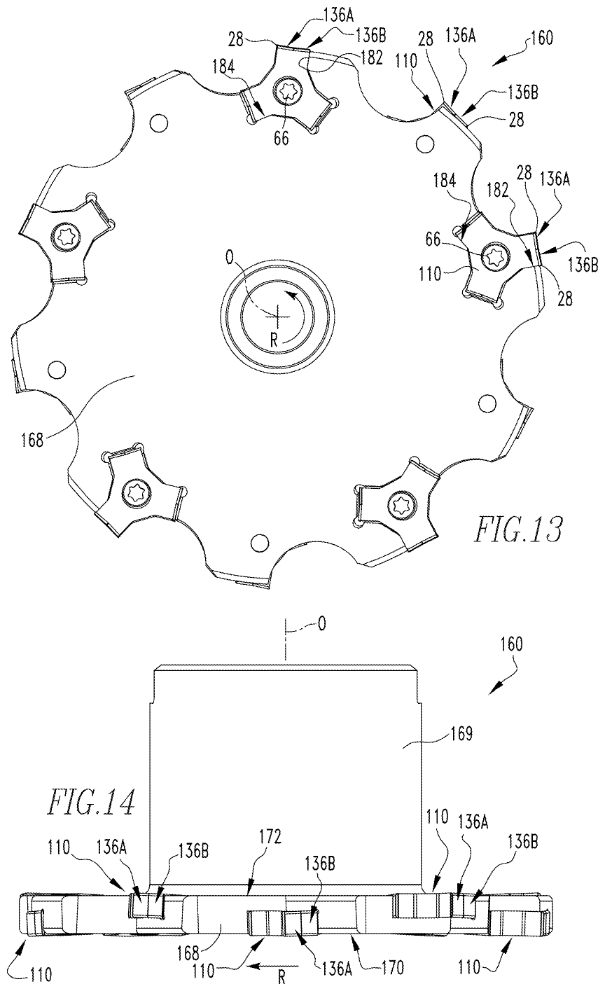

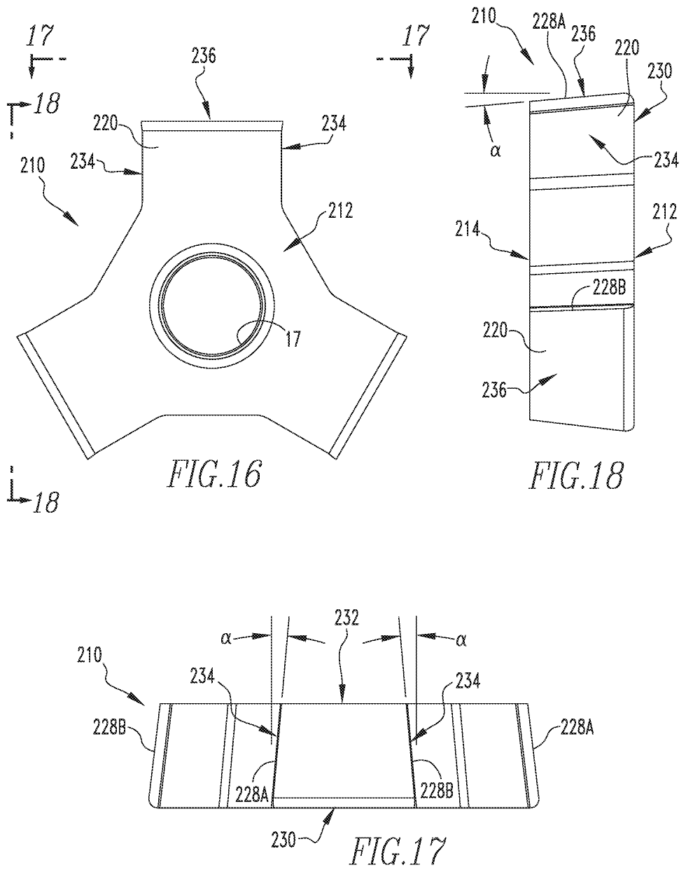

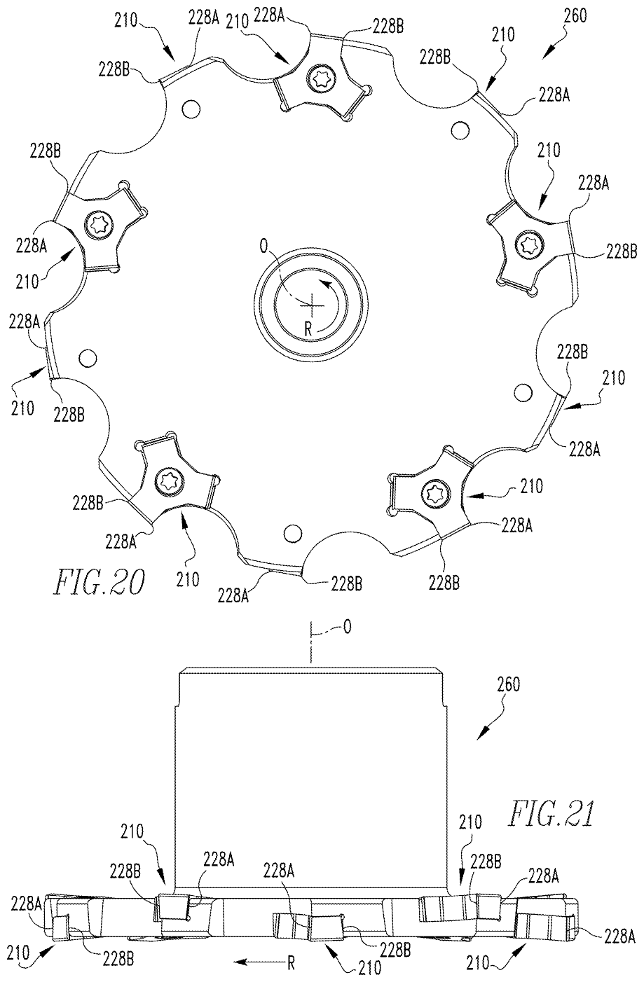

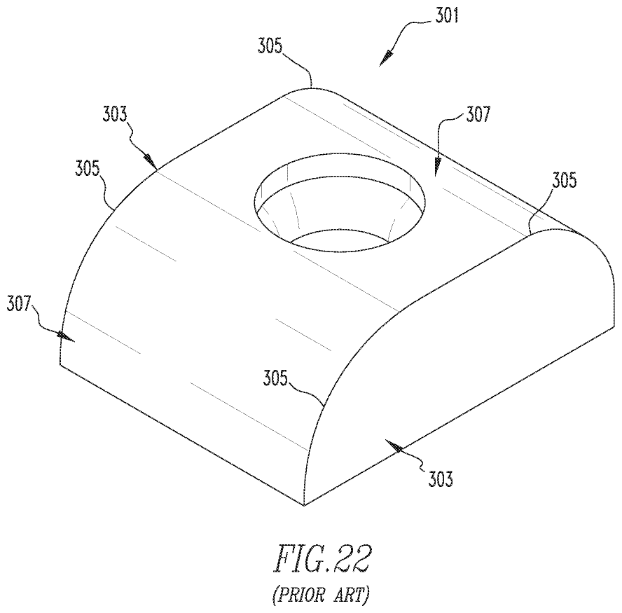

The description now turns to the figures. The illustrated embodiments of the invention will be best understood by reference to the figures. The following description is intended only by way of example and simply illustrates certain selected exemplary embodiments of the invention as claimed herein. To facilitate easier reference, in advancing from FIG. 1 to and through FIG. 21, a reference numeral is advanced by a multiple of 100 in indicating a substantially similar or analogous component or element with respect to at least one component or element found in one or more earlier figures among FIGS. 1-21.

Various views of a cutting insert 10 in accordance with one example embodiment of the present invention are shown in FIGS. 1-4. Cutting insert 10 generally includes an upper surface 12 and a lower surface 14, which are opposed or positioned opposite each other, and a peripheral side surface 16 extending between upper surface 12 and lower surface 14. Upper surface 12 and lower surface 14 are substantially parallel. An axis A disposed orthogonal to, and passing through upper surface 12 and lower surface 14 is defined for cutting insert 10. Cutting insert 10 is shaped substantially rotationally symmetrically around axis A. An insert mounting hole 17 with a central axis coinciding with axis A is defined in cutting insert 10 so as to penetrate upper surface 12 and lower surface 14.

Continuing to refer to FIGS. 1-4, cutting insert 10 includes an insert body portion 18 and three projecting portions 20 provided integrally with insert body portion 18. Insert body portion 18 includes a body portion upper surface 22, a body portion lower surface 24, and body portion side surfaces 26 extending between body portion upper surface 22 and body portion lower surface 24. Body portion upper surface 22 and body portion lower surface 24 are opposed or positioned opposite each other and substantially parallel to each other. One projecting portion 20 is arranged between any two of the three body portion side surfaces 26. The whole cutting insert 10 except for projecting portions 20 can be defined as insert body portion 18.

Insert body portion 18 is designed to substantially have a rotationally symmetric shape around axis A, that is, the central axis of insert mounting hole 17. Similarly, the three projecting portions 20 are positioned rotationally symmetrically around axis A. Thus, as described above, cutting insert 10 is shaped rotationally symmetrically around axis A.

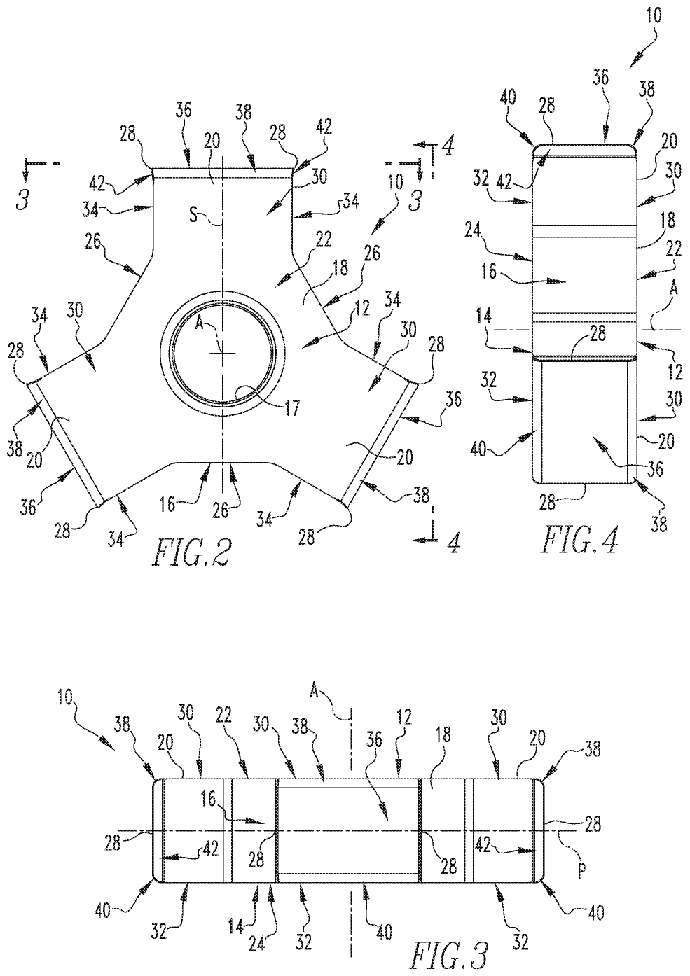

When body portion upper surface 22 of insert body portion 18 appears shaped like a triangle or substantially like a triangle, the three projecting portions 20 are located respectively, to be positioned at vertices of the triangle of body portion upper surface 22 (see FIG. 2). Projecting portions 20 are provided at outer positions of insert body portion 18 in a direction orthogonal to axis A and on the periphery of insert body portion 18. That is, projecting portions 20 are provided so as to project or extend outward from insert body portion 18.

Each of the three projecting portions 20 have substantially the same configuration. Thus, any one projecting portion 20 will be described below unless otherwise specified.

Projecting portion 20 includes a cutting edge 28 provided at the outer position of projecting portion 20 opposite body portion 18 that extends in a direction parallel to axis A. Projecting portion 20 includes a projecting portion upper surface 30 connected to body portion upper surface 22, a projecting portion lower surface 32 connected to body portion lower surface 24, two projecting portion side surfaces 34 connected to the corresponding body portion side surfaces 26, and a projecting portion side end surface 36 extending between them. In the example embodiment illustrated in FIGS. 1-4, each of projecting portion upper surface 30, projecting portion lower surface 32, projecting portion side surfaces 34, and projecting portion side end surface 36 are substantially planar. Additionally, in the example shown in FIGS. 1-4, each projection portion 20 is shaped substantially like a rectangular parallelepiped, hence upper and lower surfaces 30 and 32 are parallel, projecting portion side surfaces 34 are parallel and disposed orthogonal to each of upper and lower surfaces 30 and 32, and projecting portion side end surface 36 is disposed orthogonal to each of upper and lower surfaces 30 and 32 as well as to each of projecting portion side surfaces 34.

Projecting portion 20 further includes an upper round corner surface (curved corner surface) 38 formed thereon and extending from one of the two projecting portion side surfaces 34 to the other and between projecting portion upper surface 30 and projecting portion side end surface 36, and a lower round corner surface 40 formed thereon extending from one of two projecting portion side surfaces 34 to the other and between projecting portion lower surface 32 and projecting portion side end surface 36.

When a first plane which bisects one projecting portion 20 configured as described above is defined, the first plane can extend so as to contain the axis A. FIG. 2 shows a first plane S for one projecting portion 20. The projecting portion 20 is provided so as to be substantially bisected by first plane S and is formed substantially plane-symmetrically with respect to first plane S. Furthermore, upper and lower round corner surfaces 38 and 40 are formed to have the same or substantially the same curvature on any plane parallel to first plane S. However, upper and lower round corner surfaces 38 and 40 may have a different curvature on any plane parallel to first plane S.

Upper surface 12 of cutting insert 10 includes body portion upper surface 22 of insert body portion 18 and projecting portion upper surfaces 30 of the three projecting portions 20. Lower surface 14 of cutting insert 10 includes body portion lower surface 24 of insert body portion 18 and projecting portion lower surfaces 32 of the three projecting portions 20. Peripheral side surface 16 of cutting insert 10 includes body portion side surfaces 26 of insert body portion 18 and the projecting portion side surfaces 34 and projecting portion side end surfaces 36 of the three projecting portions 20.

Each projecting portion 20 includes two cutting edges 28 having substantially the same configuration except that the cutting edges 28 are symmetric with respect to the above-mentioned first plane S. Hence, cutting edges 28 will be described using the same reference numeral unless otherwise specified. Each cutting edge 28 is formed along an intersecting ridge portion between the projecting portion side surface 34, upper and lower round corner surfaces 38 and 40, and projecting portion side end surface 36, such that the projecting portion side surface 34 serves as a rake face. A localized rake face 42, disposed immediately adjacent cutting edge 28 between cutting edge 28 and projecting portion side surface 34 may optionally be provided as a rake face positioned at a different angle than projecting portion side surface 34. In the illustrated example, rake face 42 is disposed at 10 degrees with respect to projecting side portion 34, however, it is to be appreciated that rake face 42 may be disposed at other angles, or simply not included, without varying from the scope of the present invention. The curvature or radius of corner surfaces 38 and 40 can be appropriately changed according to the size of a curved corner surface of a groove desired to be formed in a workpiece by cutting insert 10.

Referring to FIG. 3, cutting insert 10 is symmetric about a second reference plane P disposed perpendicular to axis A midway between, and parallel to, upper and lower surfaces 12 and 14 of cutting insert 10. Hence, it is to be appreciated that cutting insert 10 is of a “neutral” design and provides for a total of six cutting edges 28 that can be utilized one at any given time in left or right-hand pockets in a cutting operation when cutting insert is disposed in one of six general index positions.

Cutting insert 10 can be produced using a hard material such as cemented carbide, coated cemented carbide, cermet, ceramic, an ultra-high pressure sintered compact containing diamond or cubic boron nitride, or any other suitable material or combination of materials.

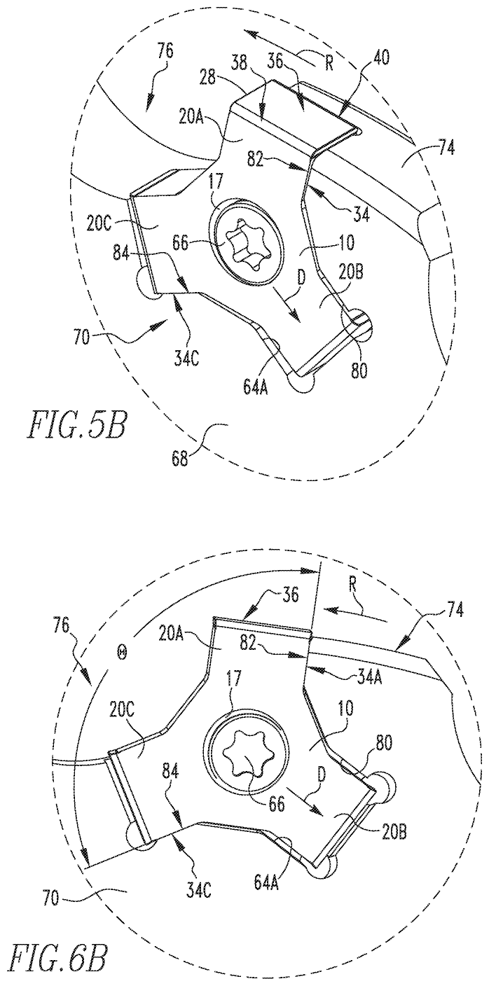

Referring now to FIGS. 5-7, an example arrangement of a cutting tool 60 having a cutter body 62 and a plurality of cutting inserts 10, such as previously described. Each cutting insert 10 is detachably mounted in a mounting seat 64 defined in cutter body 62 via a mounting screw 66 engaging insert mounting hole 17 of each cutting insert 10. During a cutting operation, cutter body 62 is rotated about an axis of rotation O in a direction R by a suitable machine tool (not shown). Cutter body 62 generally includes a substantially disc-shaped portion 68 and a shaft portion 69 extending therefrom. It is to be appreciated that alternatively, cutter body 62 may be generally formed as only disc-shaped portion 68 (i.e., no integral shaft portion 69), with one or more apertures or other suitable arrangement for mounting to a spindle of a machine tool. Disc-shaped portion 68 includes a first end surface 70, a second end surface 72, and an outer peripheral surface 74 extending between first and second end surfaces 70 and 72. First and second end surfaces 70 and 72 are opposed or positioned opposite each other and are each shaped substantially like a circle. Mounting seats 64 and corresponding chip pockets 76 are formed in outer peripheral surface 74 of cutter body 62. Each chip pocket 76 is provided so as to suitably discharge chips. Mounting seats 64 include two types of insert mounting seats 64a and 64b, each provided on outer peripheral surface 74 adjacent to and backward (i.e., trailing with respect to rotation R) of the corresponding chip pocket 76. One of insert mounting seats 64A and 64B is for the right-hand cutting edge, and the other is for the left-hand cutting edge.

First insert mounting seats 64A are open in first end surface 70. Second insert mounting seats 64B are open in second end surface 72. Thus, as well understood from FIGS. 5-7, first insert mounting seats 64A and second insert mounting seats 64B are alternately formed in first and second end surfaces 70 and 72 in a staggered manner. A plurality of cutting inserts 10, such as previously described, are mounted in mounting seats 64A and 64B. First insert mounting seats 64A and second insert mounting seats 64B are symmetrically shaped and are substantially the same in the other respects. Thus, the removable installation of the cutting insert 10 associated with any one insert mounting seat 64 will be described below.

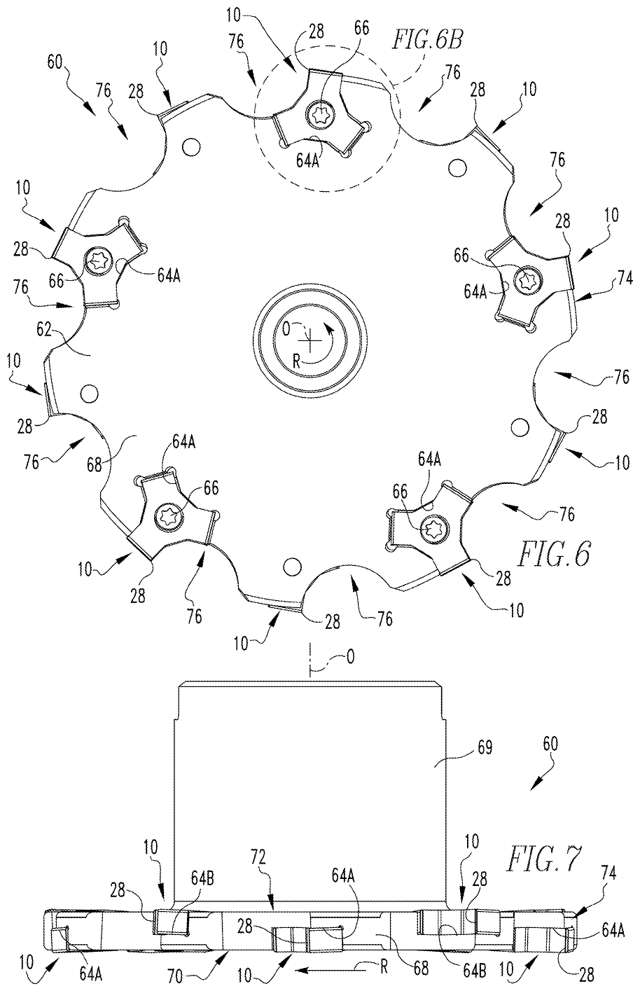

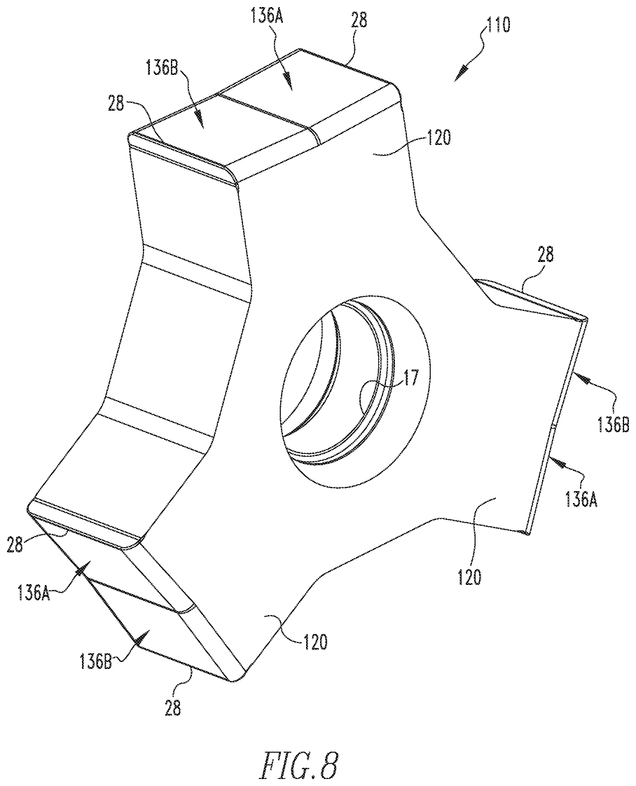

Referring to the detail views of FIGS. 5B and 6B, each cutting insert 10 is tangentially mounted in a respective insert mounting seat 64 (64A and 64B) with mounting screw 66 so that an end of cutting edge 28 projects outward from one of first end face 70 (or similarly second end face 72). When a cutting insert 10 is mounted, projecting portion side end surface 36 of a first projecting portion 20A of projecting portions 20 of cutting insert 10 substantially aligns with outer peripheral surface 74 of cutter body 62, with upper and lower round corner surfaces 38 and 40 of projecting portion 20A positioned outside outer peripheral surface 74. Insert mounting seat 64A includes a pocket 80 which is sized and structured to loosely house a second projecting portion 20B of projecting portions 20 of cutting insert 10 which generally trails first projecting portion 20A, as well as a third projecting portion 20C of projecting portions 20, with respect to rotation direction R.

Insert mounting seat 64A further includes a first contact surface 82, positioned in abutting contact with a trailing projecting side portion 34A of first projecting portion 20A, and a second contact surface 84, positioned in abutting contact with a radially inward facing projecting side portion 34C of third projecting portion 20C. As shown in FIG. 6B, in the illustrated example embodiment, first and second contact surfaces 82 and 84 are substantially planar in shape and are disposed with an angle θ of substantially 120° between the faces thereof. The positioning of first contact surface 82 directly behind the active cutting edge 28 provides for a rigid and robust support for cutting edge 28. Additionally, the positioning of second contact surface 84 in combination with first contact surface provides for a rigid and robust arrangement for securing cutting insert 10 to cutter body 62. When cutting insert 10 is simply placed in the insert mounting seat 64A, mounting hole 17 of cutting insert 10 and a threaded hole (not numbered) in insert mounting seat 64A are associated with each other so that axis A of mounting hole 17 and an axis of the threaded hole are offset a distance, typically in the range of about 0.1 mm to about 0.25 mm depending on the size of insert 10. However, in this case, axis A and that of the threaded hole are parallel, thus, when mounting screw 66 is screwed into the threaded hole in insert mounting seat 64A through mounting hole 17 in the cutting insert 10, cutting insert 10 is pressed (generally in the direction D) against first and second contact surfaces 82 and 84 of insert mounting seat 64A, thus firmly fixing cutting insert 10 in insert mounting seat 64A. When cutting insert 10 is thus mounted in insert mounting seat 64A, one usable cutting edge 28 of one projecting portion 20 (i.e., 20A) is involved in cutting. On the other hand, the two other projecting portions 20 (i.e., 20B and 20C), particularly the projecting portion 20 positioned backward in a rotation direction R of cutting tool 60, is received or housed in pocket 80 of insert mounting seat 64A in a noncontact manner.

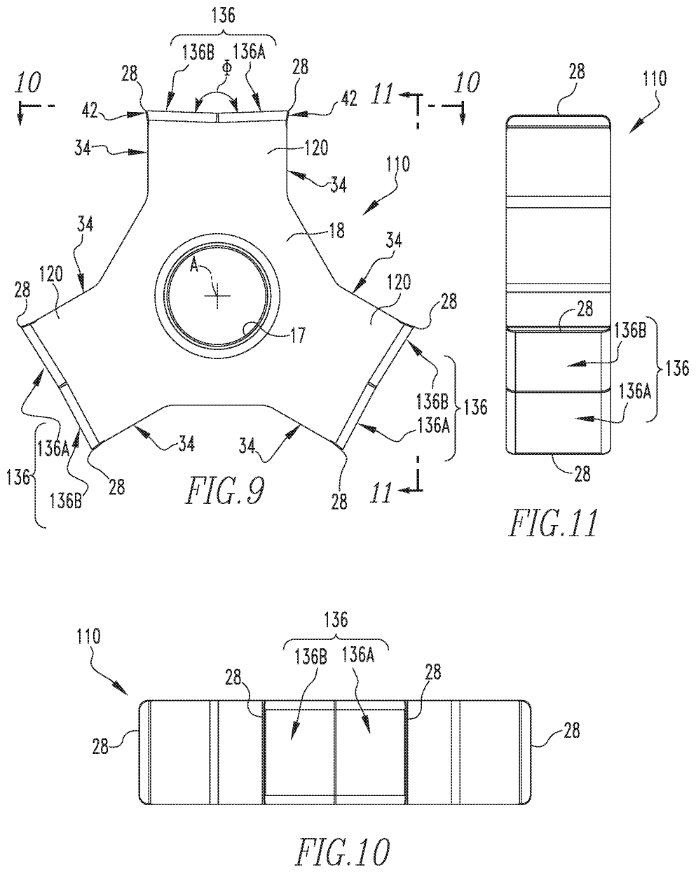

Referring now to FIGS. 8-11, various views of another cutting insert 110 in accordance with another example embodiment of the present invention are shown. Cutting insert 110 is of generally the same arrangement as cutting insert 10 of FIGS. 1-4 except, unlike each projecting portion side end surface 36 of each projecting portion 20 of cutting insert 10 which were substantially planar, each projecting portion side end surface 136 of each projecting portion 120 of cutting insert 110 is divided into a first projecting portion side end surface 136A and a second projecting portion side end surface 136B. As shown in FIG. 9, first projecting portion side end surface 136A and a second projecting portion side end surface 136B are disposed at an angle ϕ which is less than 180 degrees. Accordingly, it is to be appreciated that each first projecting portion side end surface 136A and each second projecting portion side end surface 136B form a clearance face adjacent a respective cutting edge 28 of cutting insert 110.

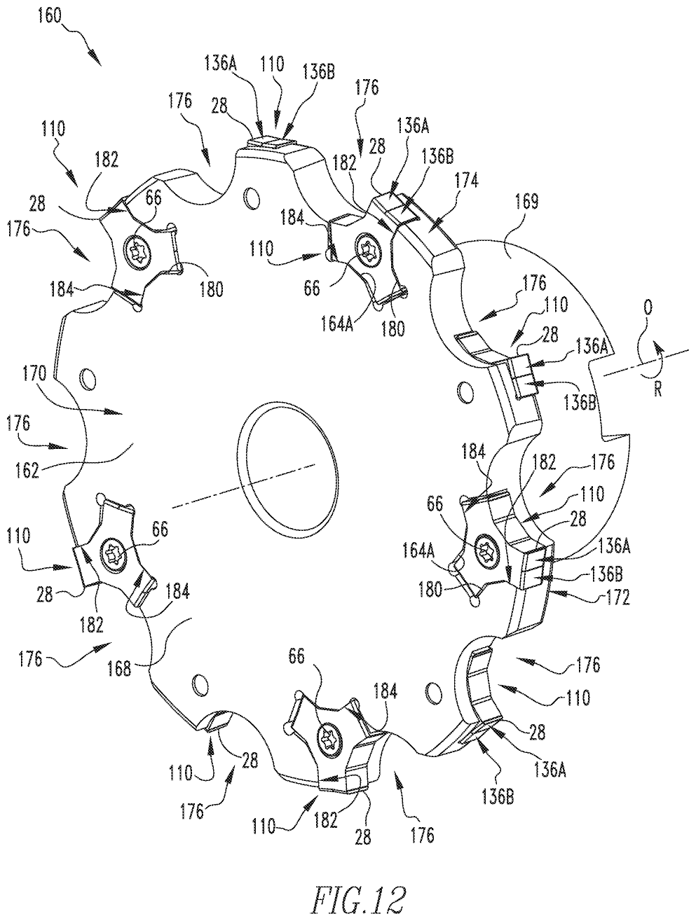

FIGS. 12-14 show an example arrangement of a cutting tool 160, similar to cutting tool 60 previously discussed, having a cutter body 162 and a plurality of cutting inserts 110 detachably mounted thereto, similar to the mounting of inserts 10 in cutter body 62 previously discussed.

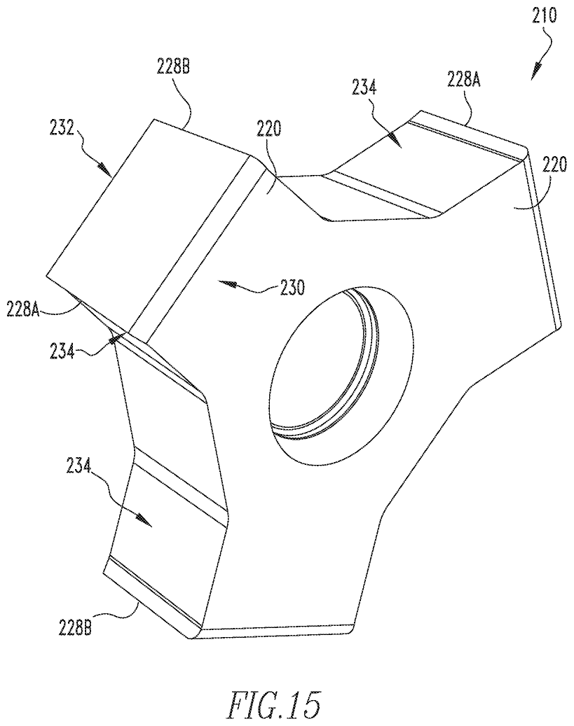

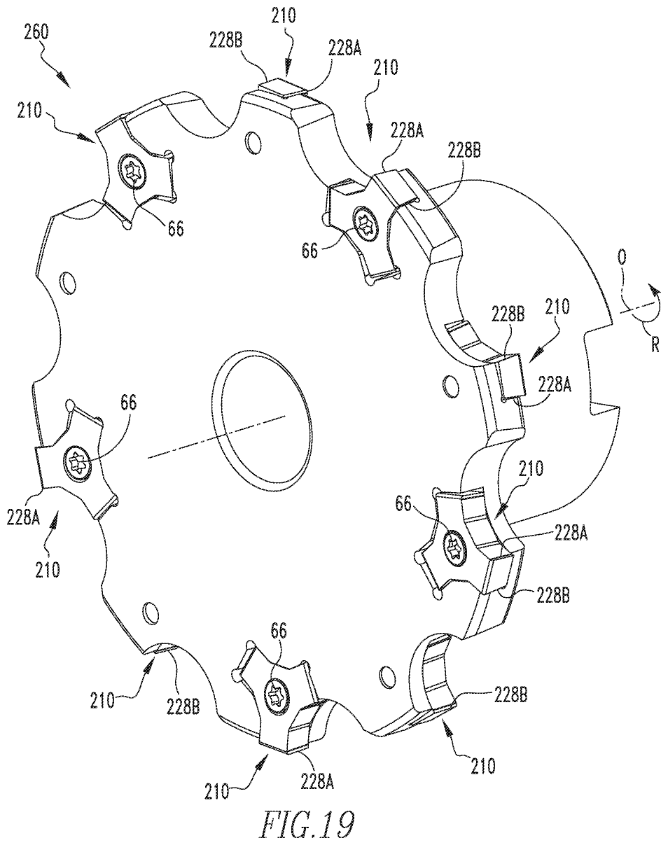

Referring now to FIGS. 15-18, various views of yet another cutting insert 210 in accordance with yet another example embodiment of the present invention are shown. Cutting insert 210 is of generally the same arrangement as cutting insert 10 of FIGS. 1-4 except, unlike each projecting portion 20 of cutting insert 10 which was shaped substantially like a rectangular parallelepiped, each projecting portion 220 of cutting insert 210 is shaped substantially like a three dimensional trapezoid with upper and lower surfaces 230 and 232 parallel, projecting portion side surfaces 234 each tapered inward (when moving from upper surface 230 to lower surface 232) at an angle a (FIGS. 17 and 18), which in one example embodiment is about 5 degrees (although other angles may be employed). Such angled arrangement provides the benefit of positive cutting action when cutting insert 210 is mounted to a cutter body as discussed below.

FIGS. 19-21 show an example arrangement of a cutting tool 260, similar to cutting tool 60 previously discussed, having a cutter body 262 and a plurality of cutting inserts 210 detachably mounted thereto, similar to the mounting of inserts 10 in cutter body 62 previously discussed.

This disclosure has been presented for purposes of illustration and description but is not intended to be exhaustive or limiting. Many modifications and variations will be apparent to those of ordinary skill in the art. The embodiments were chosen and described in order to explain principles and practical application, and to enable others of ordinary skill in the art to understand the disclosure.

Although illustrative embodiments of the invention have been described herein with reference to the accompanying drawings, it is to be understood that the embodiments of the invention are not limited to those precise embodiments, and that various other changes and modifications may be affected therein by one skilled in the art without departing from the scope or spirit of the disclosure.

1. A cutting insert comprising:
an insert body portion comprising:
a body portion upper surface;
a body portion lower surface located opposite the body portion upper surface; and
body portion side surfaces extending between the body portion upper surface and the body portion lower surface, the insert body portion being disposed about an axis (A) which passes through the body portion upper surface and the body portion lower surface; and
a plurality of projecting portions each comprising a cutting edge, each projecting portion provided integrally with the insert body portion at an outer position of the insert body portion in a direction orthogonal to the axis, wherein each projecting portion comprises:
a projecting portion upper surface connected to the body portion upper surface;
a projecting portion lower surface connected to the body portion lower surface;
two projecting portion side surfaces, each connected to the corresponding body portion side surface;
a projecting portion side end surface extending between the two projecting body portion side surfaces; and
a round corner surface formed thereon and extending between the projecting portion upper surface and the projecting portion side end surface,
wherein each cutting edge is formed between the projecting portion side surface and the projecting portion side end surface, such that the projecting portion side surface serves as a rake face,
wherein each projecting portion side surface is structured to engage either of a first contact surface or a second contact surface of a mounting seat formed in a cutter body, and
wherein all the projecting portions are identical to one another.

2. The cutting insert of claim 1, wherein each projecting portion side surface is formed as a planar surface.

3. The cutting insert of claim 1, wherein the length between the two projecting portion side surfaces is larger than a thickness of the insert body portion.

4. The cutting insert of claim 1, wherein the projecting portions are formed such that when the body portion upper surface of the insert body portion appears shaped like a polygon, the projecting portions are positioned at vertices of the polygon.

5. The cutting insert of claim 3, wherein the body portion upper surface of the insert body portion is shaped substantially like a triangle.

6. The cutting insert of claim 1, wherein: each projecting portion is formed substantially plane-symmetrically with respect to a first plane (S) that extends so as to contain the axis of the insert body portion.

7. The cutting insert of claim 1, wherein: none of the projecting portion side surfaces are visible in a top view of the insert body portion upper surface, and all of the projecting portion side surfaces are visible in a bottom view of the insert body portion lower surface.

8. The cutting insert of claim 1, wherein each projecting portion further comprises a rake face disposed at a non-zero angle between each projecting portion side surface and the projecting portion side end surface.

9. The cutting insert of claim 1, wherein each projecting portion, when viewed looking at the projecting portion side end surface thereof, is a trapezoidal shape.

10. The cutting insert of claim 1, wherein the side surfaces of each projecting portion taper inward, when moving from the projecting portion upper surface to the projecting portion lower surface, at an angle (α).

11. The cutting insert of claim 10, wherein the angle is about 5 degrees.

12. A cutter body for a rotary cutting tool, the cutter body comprising:
a first end surface and a second end surface positioned opposite the first end surface, each end surface shaped substantially like a circle;
an outer peripheral surface extending between the first end surface and the second end surfaces; and
a number of insert mounting seats provided in the tool body, each insert mounting seat being structured to support a cutting insert as recited in claim 1.

13. The cutter body of claim 12, wherein the number of insert mounting seats comprises a plurality of insert mounting seats, wherein at least one of the plurality of insert mounting seats is formed at least partially in the first and surface, and wherein at least another one of the plurality of insert mounting seats is formed at least partially in the second end surface.

14. A rotary cutting tool comprising:
a cutter body comprising:
a first end surface and a second end surface positioned opposite the first end surface, each end surface shaped substantially like a circle;
an outer peripheral surface extending between the first end surface and the second end surface; and
a number of insert mounting seats provided in the tool body; and
at least one cutting insert as recited in claim 1 coupled to the cutter body and supported in one of the number of insert mounting seats.

15. The rotary cutting tool of claim 14, wherein the number of insert mounting seats comprises a first insert mounting seat which is open in one of the first end surface or the second end surface and a second insert mounting seat which is open in the other of the first end surface or the second end surface, and wherein the at least one cutting insert comprises a first cutting insert coupled to the cutter body and supported in the first insert mounting seat and a second cutting insert coupled to the cutter body and supported in the second insert mounting seat.
